(19) United States
(12) Patent Application Publication
(10) Pub. No.: US 2003/0010705 A1
(43) Pub. Date: Jan. 16, 2003

(54) Rotary drum filter

(75) Inventor: Thomas W. Lenhart, Rockton, IL (US)

Correspondence Address: LEYDIG VOIT & MAYER, LTD, 6815 WEAVER ROAD, ROCKFORD, IL, 61114-8018, US

(73) Assignee: Barnes International Inc., Rockford, IL (US)

(21) Appl. No.: 09/904,738

(22) Filed: Jul. 13, 2001

(51) Int. Cl. B01D 33/06

(52) U.S. Cl. 210/402

(57) ABSTRACT

The present invention provides a filtering apparatus generally comprising a reservoir containing a pool of dirty fluid, the reservoir defined at least in part by a pair of laterally spaced side walls. A drum is rotatably supported within the reservoir, the drum having a generally cylindrical body having a first end, a second end, and an opening therebetween to pass fluid. A filter element is connected to the drum body and covers the opening to filter fluid flowing into the drum. The drum body is journalled about its outer surface to the reservoir for rotation therein. As such, the drum does not require any end walls to support the drum, and the entire end of the drum is wide open to the flow of fluid, which increases the rate of flow through the filter, and permits the filter to be used with a wide range of fluid flows. Unique adjustment of the drum is also provided.

### FIELD OF THE INVENTION

The present invention relates generally to apparatus for filtering dirty liquid such as machine tool coolant which contains metal chips and particles. More specifically, the invention relates to filtering apparatus of the same general type as disclosed in Lenhart U.S. Pat. No. 5,328,611.

### BACKGROUND OF THE INVENTION

In the apparatus disclosed in the Lenhart patent, a rotatable drum with a filtering screen is supported within a reservoir and is partially immersed in a pool of dirty liquid. Typically, the dirty liquid comprises machine tool coolant which is contaminated with metallic chips and particles. Coolant from that pool flows into the drum through the screen and is filtered by the screen. The clean coolant flows axially out of the drum through outlet openings in one end wall of the drum and an adjacent end wall of the reservoir. The drum includes end walls which generally comprise an outer ring connected by four spokes that meet at the center. An axle is journalled to this center portion of the end walls to support rotation of the drum.

While these systems have enjoyed much commercial success, they have both upper and lower limits on the fluid flow they can process. Generally these systems are only sized for large machine centers which produce significant quantities of dirty coolant. To accommodate such high flows of fluid, the apparatuses must be rather large in size and structured to handle such large flows. Therefore, there exists a need for a smaller filtering apparatus for smaller machine tools. However, a smaller filtering apparatus is even further limited in the amount of dirty fluid it can process. Therefore, there exists a need not only to provide a filtering apparatus suitable for use with small machining tools, but also a filtering apparatus which can at the same time be adapted for a series of small machine tools or even some larger machine centers and capable of handling their larger flows of dirty coolant.

### BRIEF SUMMARY OF THE INVENTION

In light of the above, it is a general aim of the present invention to provide a filtering apparatus suitable for use with small machine tools.

In that regard it is also an object of the present invention to provide such a filtering apparatus which is also suitable for use with a series of small machine tools or larger machine centers.

It is another object of the present invention to provide a filtering apparatus which increases the flow therethrough such that the filtering apparatus is suitable for filtering a wide range of small and large flows of dirty fluid from machine tools or centers.

In accordance with these objects, one embodiment of the present invention provides a filtering apparatus generally comprising a reservoir containing a pool of dirty fluid, the reservoir defined at least in part by a pair of laterally spaced side walls. A drum is rotatably supported within the reservoir, the drum having a generally cylindrical body having a first end, a second end, and an opening therebetween to pass fluid. A filter element is connected to the drum body and covers the opening to filter fluid flowing into the drum. The drum body is journalled about its outer surface to the reservoir for rotation therein. As such, the drum does not require any end walls to support the drum, and the entire end of the drum is wide open to the flow of fluid, which increases the rate of flow through the filter, and permits the apparatus to filter a wide range of fluid flows.

According to its more detailed aspects, this embodiment of the present invention may further comprising a pair of bearings, each bearing being connected to one side wall to rotatably support the drum body about its outer surface. Preferably, the pair of bearings are polymer bearings.

Another embodiment of the present invention provides a filtering apparatus generally comprising a reservoir containing a pool of dirty fluid, the reservoir defined at least in part by a pair of laterally spaced side walls. A drum is rotatably supported within the reservoir, the drum having a generally cylindrical body having a first end, a second end, and an opening therebetween to pass fluid. A filter element is connected to the drum body and covers the opening to filter fluid flowing into the drum. The first and second ends of the drum body are adjustably supported by the side walls, the first and second ends being independently adjustable.

According to its more detailed aspects, this embodiment of the present invention may further comprise a pair of flanges connected to the pair of side walls, the flanges supporting the ends of the drum body. Preferably, each flange includes a plurality of slotted apertures that receive bolts for attaching the flange to the side wall. Moreover, the plurality of slotted apertures are oriented to permit omni-directional adjustment of each end of the drum body. As in the above embodiment, the drum body is journalled about its outer surface to eliminate the need for end walls on the drum body.

Yet another embodiment of the present invention provides a filtering apparatus generally comprising a reservoir containing a pool of dirty fluid, the reservoir defined at least in part by a pair of laterally spaced side walls. A drum is rotatably supported within the reservoir, the drum having a generally cylindrical body having a first end, a second end, and an opening therebetween to pass fluid. A filter element is connected to the drum body and covers the opening to filter fluid flowing into the drum. The apparatus also includes a pair of laterally spaced bearings, each bearing connected to one side wall to rotatably support the drum body about the outer surface. Finally, the apparatus further includes a pair of laterally spaced seals. The pair of seals are mounted to the outer surface of the drum body and engage the pair of side walls to provide a fluidic seal therebetween. Preferably, each seal is located laterally inside each bearing to seal the bearing from dirty fluid and to keep fine chips from returning to the clean coolant tank.

According to its more detailed aspects, this embodiment of the present invention may further comprise a pair of laterally spaced flanges adjustably connected to the pair of side walls. Here, the bearings are connected to the flanges to support the ends of the drum body about the outer surface, while the seals engaging the flanges to provide a fluidic seal therebetween. Preferably, each flange is independently adjustable relative to the side wall to which it is connected.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a front view of an embodiment of the filtering apparatus constructed in accordance with the teachings of the present invention.

FIG. 2 is a cross-sectional view of the filtering apparatus of FIG. 1 taken about line 2-2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

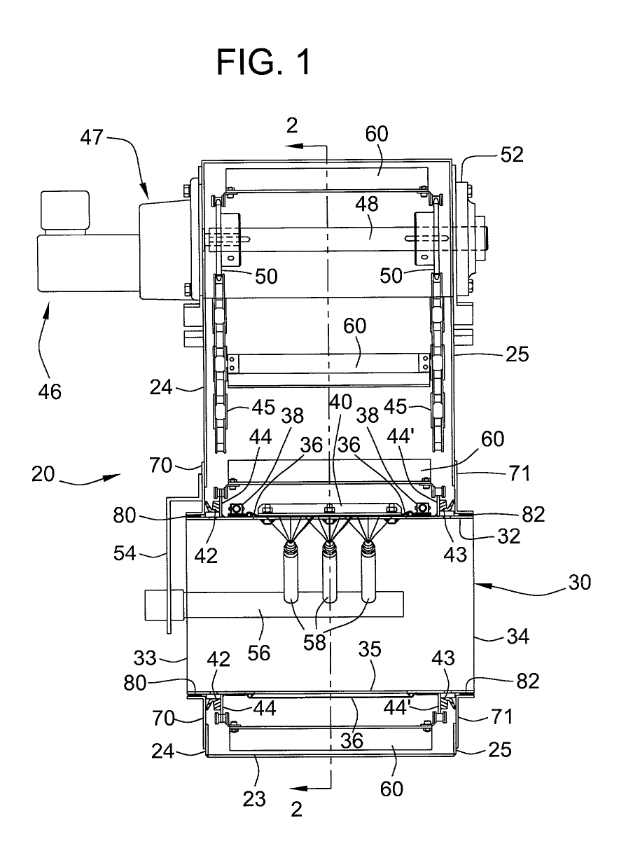

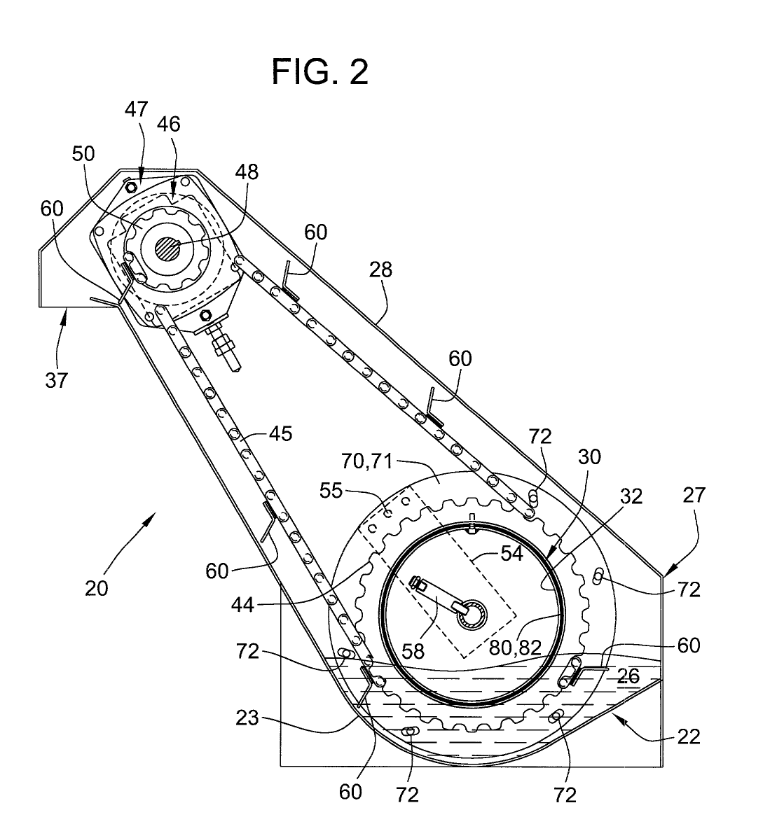

Referring now to the drawings, FIGS. 1 and 2 show an embodiment of the present invention. This embodiment generally comprises a filtering apparatus 20 for filtering dirty fluid and for producing a flow of clean fluid. The fluid may, for example, be machine tool coolant which is contaminated with metallic chips and particles.

The filtering apparatus 20 includes a dirty coolant reservoir 22 defined in part by a bottom wall 23 and a pair of laterally spaced side walls 24 and 25 and containing a pool 26 of dirty coolant (FIG. 2). Dirty coolant enters the reservoir 22 by way of an inlet which exists in the area indicated generally by numeral 27 in FIG. 2. A filter drum 30 is located at least partially between the side walls 24, 25 and is partially immersed in the pool 26 of dirty coolant. The drum 30 includes a generally cylindrical body 32 having a first end 33 and a second end 34. Between the opposing ends 33, 34 of the drum body 32, the drum includes a central portion 35 having at least one opening therein for passing fluid. Preferably, the central portion 35 of the drum body 32 includes a series of circumferentially spaced slots which are separated by thin reinforcing strips of drum body material. A flat filter belt is wrapped around the drum 30 to form a tubular filter element 36 that extends between the ends 33, 34 of the drum body 32, proximate the openings 35, to filter dirty coolant passing therethrough. Preferably, the filter element is a fine screen mesh belt. The filter element 36 is retained on the outer surface of the drum by laterally spaced clamps 38 which cooperates with a filter belt clamp plate 40 to securely position the filter element 36.

The drum 30 is adapted to be rotated within the reservoir 22. In the present embodiment, the rotation is effected by a pair of laterally spaced chains 45 operably engaged with the outside of the drum via a sprocket 44 connected to the outer surface of the drum body 32. A guide 44′ is also connected to the outer surface of the drum and is laterally spaced from the sprocket to guide the other laterally spaced chain 45. At the other end of the chains 45 drive sprockets 50 are keyed to a drive shaft 48 operably connected to a motor 46 through a gear box or speed reducer 47. The end of the drive shaft 48 opposite the motor 46 is supported by a bearing 52 which selectively mounts to the side wall 25 of the reservoir. It will be understood that the filtering apparatus of the present invention may be used as a left handed or a right handed machine. More specifically, the bearing within the motor 46 is utilized such that the entire motor 46, gear box 47, drive shaft 48, sprocket 50 and bearing 52 may be flipped 180° to reverse the orientation of the machine.

Heavy chips in the dirty coolant entering the inlet 27 settle to the bottom of the reservoir 23 and are carried upwardly by drag bars or scrapers 60 which span the chains 45 These heavy chips are carried along the bottom wall 23 of the reservoir 22 and are discharged through an outlet 37. A hand cart (not shown) may be positioned below the outlet 37 and may be periodically dumped.

Lighter chips and fine particles in the dirty pool 26 are filtered by the screen mesh 36 as the coolant passes upwardly through the filter element 36 and the openings in the drum body 32 and into the interior of the drum 30. Clean coolant which is filtered by the screen mesh 36 flows axially out of one end of the drum and collects in a clean coolant tank (not shown). A pump may be associated with the tank to deliver clean coolant to machine tools or other devices which may utilize said coolant. Clean coolant is also pumped to spray nozzles 58 located inside of the drum 30 and directed towards the inner face of the filter element 36. As the drum rotates, the clean coolant from the nozzles 58 continuously backwashes the filter element 36 flush filtered out particles therefrom. Such particles accumulate on the bottom wall 23 of the reservoir 22 and are carried away by the scrapers 60 in the form of sludge.

According to the present invention, the filtering apparatus 20 is structured to accommodate the flow of dirty coolant from small machine tools, but also increases the flow handling capability of the filtering apparatus to increase its versatility. Notably, the drum 30 is journalled about its outer surface to the side walls 24, 25 of the reservoir 22. Moreover, the invention includes provision for independently adjusting each end of the cylinder barrel relative to the reservoir to ensure smooth actuation and well as close tolerancing of the scrapers 60 with the bottom wall 23 of the reservoir 22 to ensure efficient removal metallic chips and particles. By journalled the drum 30 about its outer surface, the drum need only comprise a generally cylindrical body 32, and need not include any end walls at the ends 33, 34 of the body 32 for engaging a hub or axle about those end walls, i.e. within the interior of the drum 30. Accordingly, the end of the drum is free of restriction and hence increases the flow out of an axial end of the drum 30. Furthermore, the point at which fluid is exiting the drum 30 has been lowered by removing any such end walls or spokes, also increasing the flow of clean coolant exiting the drum 30.

As shown in the figures, two laterally spaced generally circular flanges 70, 71 are connected to the side walls 24, 25, respectively. Each flange 70, 71 is generally L-shaped in cross-section to provide an inner peripheral surface having a bearing 80, 82 for journalling the outer surface of the drum body 32. Preferably, the bearings 80, 82 are polymer bearings, and in the preferred embodiment have been selected as turcite, although it will be recognized in the art that any other suitable bearings such as other low-friction material bearings, roller bearings, slipper bearings, etc., can also be used in conjunction with the present invention. Two laterally spaced seals 42, 43 are also provided to serve as a boundary between the pool of dirty coolant 26 and the clean coolant exiting axially from the drum 30. The seals 42, 43 are V-type seals as is well known in the art. Preferably, each seal ring 42, 43 is attached to the outer surface of the drum adjacent to, and laterally outward of the laterally spaced chain guide 44′ and sprocket 44 driving the drum 30. As such, the seals 42, 43 rotate with the drum 30 and the entire seal can be easily inspected for excessive wear. In the illustrated embodiment the seals 42, 43 seal to the adjustable flanges 70, 71 which are connected to and extend from the side walls 24, 25. While the seals in the past have abutted the side walls, the seal are intended to seal to the flanges which are easier to manufacture uniformly than the side wall, thereby providing a stronger and more reliable seal.

Each end 33, 34 of the drum is adjustable by virtue of their connection to the side walls 24, 25 via the intermediary of flanges 70, 71. As best seen in FIG. 2, each flange 70, 71 includes a plurality of slotted apertures 72 spaced around the periphery of the flange. Studs are used to connect the flanges 70, 71 to the side walls 24, 25 via the slotted apertures 72. The axis of each slotted aperture 72 is oriented relative to the other axes of the other aperture 72 to permit the flanges 70, 71 to be easily adjusted. A pipe bracket 54 is also attached to the flange 70 and supports a spray pipe 56 which feeds clean coolant to the nozzles 58 for cleaning the filter element 36. A central stud 55 not only connects the bracket 54 to the flange 70, but also extends through the side wall 24. A stud (not shown) links the other flange 71 to the side wall 25 in a similar manner. As such, the stud acts as a pivot point about which the drum 30 rotates to adjust its relative position within the apparatus 20, making adjustment easy since the barrel 30 need not be lifted.

It will be recognized that by virtue of mounting the spray pipe 56 and nozzles 58 to the circular flange 70, as well as the bearings 80, 82 to the flanges 70, 71, each end 33, 34 of the drum 30 may be independently adjusted in relation to the side walls 24, 25, yet the filter element 36 will be properly cleaned and the drum 30 will be properly supported rotationally regardless of the independent adjustments of each end 33, 34 of the drum 30. It will also be recognized by locating the seals 42, 43 laterally inside the bearings 80, 82, the bearings are separated from dirty coolant. Thus the metal chips and particles will not interrupt their function. Similarly, the bearings 80, 82 will be lubricated only by clean fluid exiting axially out of the drum adjacent the bearings. Furthermore, the seals 42, 43 will always be properly positioned to reliably seal against the flanges 70, 71, regardless of the independent adjustment of each drum end 33, 34. By virtue of each end 33, 34 of the drum 30 being independently adjustable, proper orientation of the drum 30 relative to the drive shaft 48 and sprockets 50, as well as the chains 45 is ensured. Additionally, the relative position of the scraper 60 to the bottom wall 23 of the reservoir 22 can be accurately controlled to ensure a efficient and smooth removal of particles from the bottom of the reservoir 22 upwards to the outlet 37.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A filtering apparatus comprising;
a reservoir containing a pool of dirty fluid, the reservoir defined at least in part by a pair of laterally spaced side walls;
a drum rotatably supported within the reservoir, the drum having a generally cylindrical body having a first end, a second end, and an opening therebetween to pass fluid,
a filter element connected to the drum body and covering the opening to filter fluid flowing into the drum; and
the drum body being journalled about its outer surface to the reservoir for rotation therein.

2. The filtering apparatus of claim 1, further comprising a pair of bearings, each bearing connected to one side wall to rotatably support the drum body about the outer surface.

3. The filtering apparatus of claim 2, wherein the pair of bearings are polymer bearings.

4. The filtering apparatus of claim 1, wherein the first and second ends of the drum body are independently adjustable relative to the side walls of the reservoir.

5. The filtering apparatus of claim 1, further comprising a pair of flanges connected to the pair of side walls, the flanges supporting the ends of the drum body about the outer surface.

6. The filtering apparatus of claim 5, wherein each flange is adjustable relative to the side wall to which it is connected.

7. The filtering apparatus of claim 6, wherein each flange is pivotally connected to the respective side wall and includes a plurality of slotted apertures that receive bolts for attaching the flange to the side wall, the plurality of slotted apertures oriented relative to the pivotal connection to permit adjustment of each end of the drum body.

8. The filtering apparatus of claim 1, wherein the drum includes no end walls.

9. A filtering apparatus comprising;
a reservoir containing a pool of dirty fluid, the reservoir defined at least in part by a pair of laterally spaced side walls;
a drum rotatably supported within the reservoir, the drum having a generally cylindrical body having a first end, a second end, and an opening therebetween to pass fluid,
a filter element connected to the drum body and covering the opening to filter fluid flowing into the drum; and
the first and second ends of the drum body being adjustably supported by the side walls, the first and second ends being independently adjustable.

10. The filtering apparatus of claim 9, further comprising a pair of flanges connected to the pair of side walls, the flanges supporting the ends of the drum body.

11. The filtering apparatus of claim 10, wherein each flange includes a plurality of slotted apertures that receive studs for attaching the flange to the side wall.

12. The filtering apparatus of claim 11, wherein each flange is pivotally connected to the respective side wall, and the plurality of slotted apertures are oriented relative to the pivotal connection to permit adjustment of each end of the drum body.

13. The filtering apparatus of claim 9, wherein the drum body is journalled about its outer surface to the side walls of the reservoir for rotation therein.

14. The filtering apparatus of claim 13, further comprising a pair of laterally spaced bearings, each bearing connected to one side wall to rotatably support the drum body about the outer surface.

15. The filtering apparatus of claim 13, further comprising a pair of laterally spaced seals mounted to the outer surface of the drum and engaging the pair of side walls to provide a fluidic seal therebetween.

16. The filtering apparatus of claim 15, wherein each seal is located laterally inside each bearing to seal the bearing from dirty fluid.

17. A filtering apparatus comprising;
a reservoir containing a pool of dirty fluid, the reservoir defined at least in part by a pair of laterally spaced side walls;
a drum rotatably supported within the reservoir, the drum having a generally cylindrical body having a first end, a second end, and an opening therebetween to pass fluid,
a filter element connected to the drum body and covering the opening to filter fluid flowing into the drum;
a pair of laterally spaced bearings, each bearing connected to one side wall to rotatably support the drum body about the outer surface; and
a pair of laterally spaced seals mounted to the outer surface of the drum body and engaging the pair of side walls to provide a fluidic seal therebetween, each seal being located laterally inside each bearing to seal the bearing from dirty fluid.

18. The filtering apparatus of claim 17, further comprising a pair of laterally spaced flanges adjustably connected to the pair of side walls, the bearings connected to the flanges to support the ends of the drum body about the outer surface, the seals engaging the flanges to provide a fluidic seal therebetween.

19. The filtering apparatus of claim 18, wherein each flange is independently adjustable relative to the side wall to which it is connected.

20. The filtering apparatus of claim 18, wherein each flange is pivotally connected to the respective side wall, and the plurality of slotted apertures are oriented relative to the pivotal connection to permit adjustment of each end of the drum body, a plurality of slotted apertures that receive studs for attaching the flange to the side wall, the plurality of slotted apertures oriented to permit omni-directional adjustment of each end of the drum body.
